(19) United States
(12) Patent Application Publication
(10) Pub. No.: US 2016/0034972 A1
(43) Pub. Date: Feb. 4, 2016

(54) GENERATING AND USING AD SERVING GUARANTEES IN AN ONLINE ADVERTISING NETWORK

(71) Applicants: Ross Koningstein, Menlo Park, CA (US); Keith Randall, Los Altos Hills, CA (US); Hal Varian, Danville, CA (US); Eric Hugh Veach, Bellevue, WA (US)

(72) Inventors: Ross Koningstein, Menlo Park, CA (US); Keith Randall, Los Altos Hills, CA (US); Hal Varian, Danville, CA (US); Eric Hugh Veach, Bellevue, WA (US)

(21) Appl. No.: 12/173,600

(22) Filed: Jul. 15, 2008

(51) Int. Cl. G06Q 30/02; G06Q 10/00

(52) U.S. Cl. CPC G06Q 30/0275

(57) ABSTRACT

An ad serving system accepts a request for one or more ads, determines a set of eligible ads from among ads having a guaranteed serving reservation and ads with uncommitted serving. This may be done using information from the accepted request, wherein the set of eligible ads may include at least one ad having a guaranteed serving reservation and at least one ad with uncommitted serving. A set of ads to serve is determined from the set of eligible ads using an arbitration process, and the determined set of ads is served. Ad serving guarantees may be generated and/or desired ad serving guarantees may be checked using an inventory test and/or a price test.

### §1. BACKGROUND OF THE INVENTION

§1.1 Field of the Invention

The present invention concerns advertising networks, such as online advertising networks for example. In particular, the present invention concerns generating and using ad serving guarantees.

§1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as an effective way to advertise and influence users.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords™ advertising system by Google, Inc. of Mountain View, Calif. (referred to as “Google”), delivers ads targeted to keywords from search queries. Similarly, content targeted ad delivery systems have been proposed. For example, U.S. patent application Ser. No. 10/314,427 (incorporated herein by reference and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense™ advertising system by Google, Inc. for example, have been used to serve ads on Web pages.

As can be appreciated from the foregoing, serving ads relevant to concepts of text in a text document and serving ads relevant to keywords in a search query are useful because such ads presumably concern a current user interest. Consequently, such online advertising has become increasingly popular.

Regardless of whether or how ads are targeted, an advertiser typically compensates the content owner (referred to more generally as a “document publisher” or “Web publisher”) and perhaps an ad serving entity. Such compensation may occur whenever the ad is served (per impression), or may be subject to a condition precedent such as a selection, a conversion, etc. Compensation per selection (commonly referred to as “pay per click”) is currently becoming popular. As an example, each time a user selects an ad, they are typically brought to (e.g., their browser loads) a corresponding landing page linked from the ad. The advertiser compensates the Web publisher for the selection.

In some cases, it may be difficult for an advertiser to predict how its ads will be served, how many impressions, selections and/or conversions their ads will receive, how much its online advertisements will cost (in total, or average cost per impression, selection and/or conversion) over a given period, etc. Although many online ad serving systems provide budgeting tools (e.g., controls that set upper and/or lower limits), some advertisers still would nonetheless like to be able to participate in online advertising using guarantees (e.g., contractual guarantees). Ad serving entities, however, are sometimes reluctant to enter into contractual guarantees since they increase various risks.

As can be appreciated from the foregoing, it would be useful to help online ad serving entities to accommodate advertisers seeking online advertising-related guarantees.

### §2. SUMMARY OF THE INVENTION

Embodiments consistent with the present invention can be used to determine ad serving guarantees and to use such guarantees when serving ads in an online advertising network. Embodiments consistent with the present invention might do so by (a) accepting a request for an ad serving guarantee, the request including (1) a time period, (2) at least one ad serving constraint, and (3) a guarantee specifying at least one of (A) a guaranteed spend, (B) a guaranteed number of impressions, (C) a guaranteed number of selections, and (D) a guaranteed number of conversions, (b) applying the requested ad serving guarantee to an ad spot inventory test to generate an inventory test result, (c) determining a reply to the request based on the inventory test result; and (d) forwarding the determined reply towards a user device for rendering. At least some other embodiments consistent with the present invention might do so by (a) accepting a request for an ad serving guarantee, the request including (1) a time period, (2) at least one ad serving constraint, (3) a guarantee specifying at least one of (A) a guaranteed spend, (B) a guaranteed number of impressions, (C) a guaranteed number of selections, and (D) a guaranteed number of conversions, and (4) a price guarantee, (b) determining a price for the requested ad serving guarantee using an estimated or accepted market value of the at least one ad serving constraint of the request over the time period for the request, (c) applying the requested price guarantee and the determined price to a price test to generate a price test result, (d) determining a reply to the request based on the price test result, and (e) forwarding the determined reply towards a user device for rendering. At least some other embodiments consistent with the present invention might do so by (a) accepting a request for an ad serving guarantee, the request including (1) a time period, (2) at least one ad serving constraint, (3) a guarantee specifying at least one of (A) a guaranteed spend, (B) a guaranteed number of impressions, (C) a guaranteed number of selections, and (D) a guaranteed number of conversions, and (4) a price guarantee, (b) determining a price for the requested ad serving guarantee using an estimated or accepted market value of the at least one ad serving constraint of the request over the time period for the request, (c) applying the requested price guarantee and the determined price to a price test to generate a price test result, (d) applying the requested ad serving guarantee to an ad spot inventory test to generate an inventory test result, (e) determining a reply to the request using both the inventory test result and the price test result, and (f) forwarding the determined reply towards a user device for rendering.

In at least some embodiments consistent with the present invention, the act of applying the requested ad serving guarantee to an ad spot inventory test to generate an inventory test result includes (1) forecasting a number of ad spots expected in the time period of the request, and meeting the at least one ad serving constraint, (2) accepting a predetermined maximum percentage of forecast ad spot inventory available for reservation, (3) determining whether the requested one of (A) a guaranteed spend, (B) a guaranteed number of impressions, (C) a guaranteed number of selections, and (D) a guaranteed number of conversions, would exceed the predetermined maximum percentage, and (4) generating an inventory test result of FAIL if it was determined that the requested one of (A) a guaranteed spend, (B) a guaranteed number of impressions, (C) a guaranteed number of selections, and (D) a guaranteed number of conversions, would exceed the predetermined maximum percentage, otherwise generating an inventory test result of PASS, and wherein the act of applying the requested price guarantee and the determined price to a price test to generate a price test result includes (1) determining whether the requested guarantee price exceeds the determined price by a predetermined safety margin, and (2) if it is determined that the requested guarantee price exceeds the determined price by a predetermined safety margin, then generating a price test result of PASS, otherwise generating a price test result of FAIL. In at least some of these embodiments, the reply to the request may indicate an acceptance of the guarantee only if both (1) the price test result is PASS and (2) the inventory test result is PASS. In at least some other of these embodiments, the reply to the request indicates a decline of the guarantee if either (A) the price test result is FAIL, or (B) the inventory test result is FAIL. In at least some other of these embodiments, the reply to the request indicates (1) a decline of the requested guarantee and (2) an alternative guarantee if the inventory test result is FAIL. In at least some other of these embodiments, the reply to the request indicates (1) a decline of the guarantee, and (2) an alternative guarantee price if the price test result is FAIL.

In at least some embodiments consistent with the present invention, the at least one ad serving constraint includes at least one keyword for targeting the serving of the ad. In at least some embodiments consistent with the present invention, the at least one ad serving constraint includes a plurality of keywords for targeting the serving of the ad, and wherein the determined reply includes, for each of the plurality of keywords, at least one of (A) a guaranteed fixed price per impression, (B) a guaranteed fixed price per selection, and (C) a guaranteed fixed price per conversion.

In at least some embodiments consistent with the present invention, the determined reply includes, for each of the at least one serving constraints, at least one of (A) a guaranteed fixed price per impression, (B) a guaranteed fixed price per selection, and (C) a guaranteed fixed price per conversion.

In at least some embodiments consistent with the present invention, the at least one ad serving constraint includes a plurality of keywords for targeting the serving of the ad, and wherein the determined reply includes (1) at least one of (A) a guaranteed fixed price per impression of an ad served pursuant to any of the plurality of keywords, (B) a guaranteed fixed price per selection of an ad served pursuant to any of the plurality of keywords, and (C) a guaranteed fixed price per conversion of an ad served pursuant to any of the plurality of keywords, and (2) at least one of (A) a guaranteed number of ad impressions over the time period, (B) a guaranteed number of ad selections over the time period, and (C) a guaranteed number of ad conversions over the time period.

In at least some embodiments consistent with the present invention, the determined reply includes (1)at least one of (A) a guaranteed fixed price per impression of an ad served pursuant to any of the at least one serving constraint, (B) a guaranteed fixed price per selection of an ad served pursuant to any of the at least one serving constraint, and (C) a guaranteed fixed price per conversion of an ad served pursuant to at least one serving constraint, and (2) at least one of (A) a guaranteed number of ad impressions over the time period, (B) a guaranteed number of ad selections over the time period, and (C) a guaranteed number of ad conversions over the time period.

At least some embodiments consistent with the present invention may serve both ads priced using a reservation system and ads using bids. For example, at least some embodiments consistent with the present invention might do so by (a) accepting a request for one or more ads, (b) determining a set of eligible ads from among ads having a guaranteed serving reservation and ads with uncommitted serving, using information from the accepted request, wherein the set of eligible ads may include at least one ad having a guaranteed serving reservation and at least one ad with uncommitted serving, (c) determining a set of ads to serve from the set of eligible ads using an arbitration process; and (d) serving the determined set of ads.

### §3. BRIEF DESCRIPTION OF THE DRAWINGS

FIG. 1 is a diagram showing parties or entities that can interact with an advertising system.

FIG. 2 is a diagram illustrating an environment in which, or with which, embodiments consistent with the present invention may operate.

FIG. 3 is a bubble diagram illustrating exemplary advertising guarantee generation and/or checking operations that might be performed in an embodiment consistent with the present inventions, as well as information that may be used and/or generated by such operations.

FIG. 4 is a bubble diagram illustrating exemplary ad serving operations, as well as information used and/or generated by such operations, consistent with the present invention.

FIG. 5 is a flow diagram illustrating an exemplary method for performing an inventory test for an advertising guarantee check, in a manner consistent with the present invention.

FIG. 6 is a flow diagram illustrating an exemplary method for performing a price test for an advertising guarantee check, in a manner consistent with the present invention.

FIG. 7 is a flow diagram illustrating an exemplary method for performing both an inventory test and a price test for an advertising guarantee check, in a manner consistent with the present invention.

FIG. 8, which includes FIGS. 8A and 8B, is a flow diagram illustrating an exemplary method for generating and and/or checking advertising guarantees in a manner consistent with the present invention.

FIG. 9 is a flow diagram illustrating an exemplary method for testing the quality of ad serving constraints (i.e., ad targeting information) included in an advertising guarantee request, in a manner consistent with the present invention.

FIG. 10 is flow diagram illustrating an exemplary method for serving ads in a manner consistent with the present invention.

FIG. 11 is a block diagram of apparatus that may be used to perform at least some operations, and store at least some information, in a manner consistent with the present invention.

FIG. 12 is a diagram illustrating spot prices, an average price, and a premium price for a given serving constraint or a given set of serving constraints over a given time period.

### §4. DETAILED DESCRIPTION

The present invention may involve novel methods, apparatus, message formats, and/or data structures for generating or checking advertising guarantees. The present invention may also involve novel methods, apparatus, message formats, and/or data structures for serving ads, at least some of which may be subject to advertising guarantees, in an online advertising network.

The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventor regards his invention to include any patentable subject matter described.

In the following, definitions of terms that may be used in the specification are provided in §4.1. Then, environments in which, or with which, the present invention may operate are described in §4.2. Exemplary embodiments of the present invention are described in §4.3. Thereafter, specific examples illustrating uses of exemplary embodiments of the present invention are provided in §4.4. Finally, some conclusions regarding the present invention are set forth in §4.5.

§4.1 Definitions

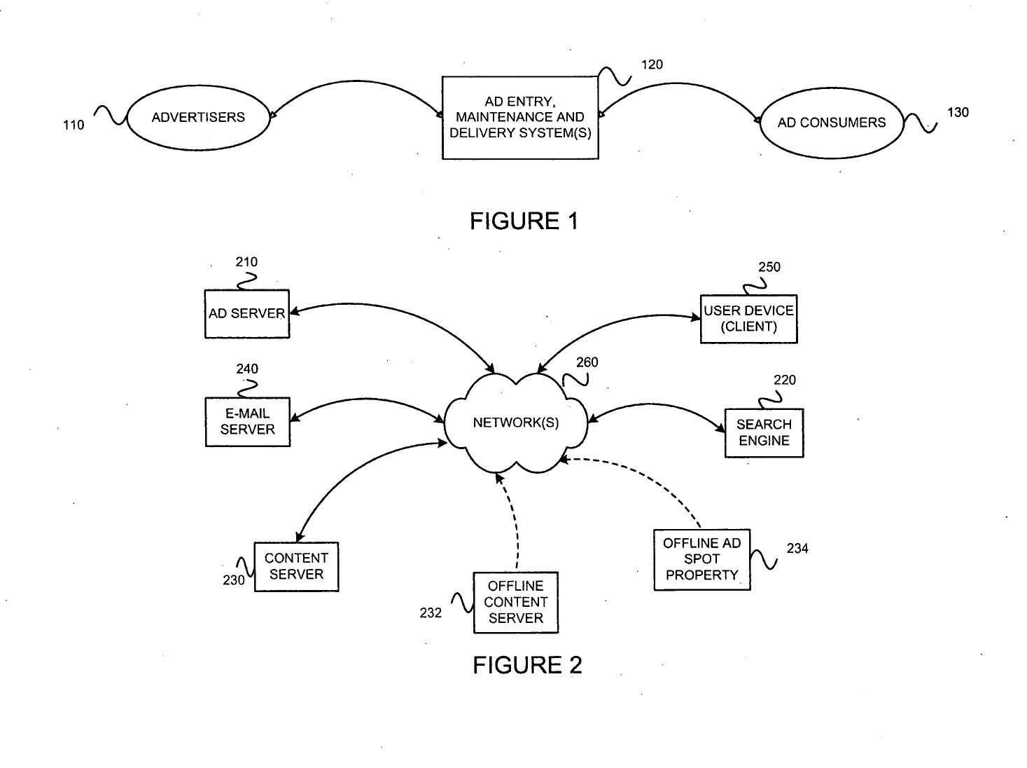

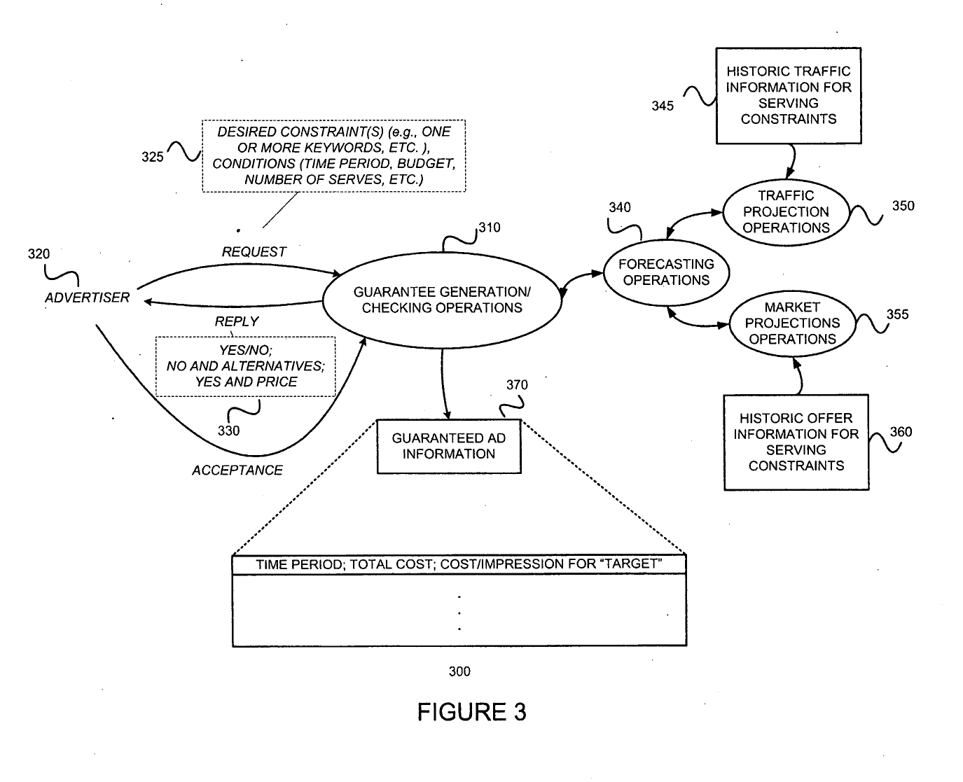

Online ads, such as those used in the exemplary systems described below with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet, another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered into an advertising system the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner. A “document publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

§4.2 Exemplary Advertising Environments in Which, or with Which, Embodiments Consistent with the Present Invention may Operate

FIG. 1 is a diagram of an advertising environment in which, or with which, embodiments consistent with the present invention may operate. The environment may include an ad entry, maintenance and delivery system (simply referred to as an ad server) 120. One or more ad servers 120 may be operated under the control of an ad serving entity. Advertisers 110 may directly, or indirectly, enter, maintain, and track ad information (such as requests for advertising guarantees, acceptance of a generated advertising guarantee proposal or offer, etc.) in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application (or may have at least some similar features). An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (e.g., per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways. For example, one or more ad, ad group and ad campaign may have an associated advertising guarantee, such as the guarantees described below.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 230 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities. Network(s) 260 may be used to interconnect the various servers/devices described above. Such network(s) 260 may illustratively include the Internet or private networks.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Additionally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under, over, or otherwise in association with an e-mail.

Although the foregoing examples described servers as (i) requesting ads, and (ii) combining them with content, one or both of these operations may be performed by a client device (such as an end user computer for example).

§4.3 Exemplary Embodiments

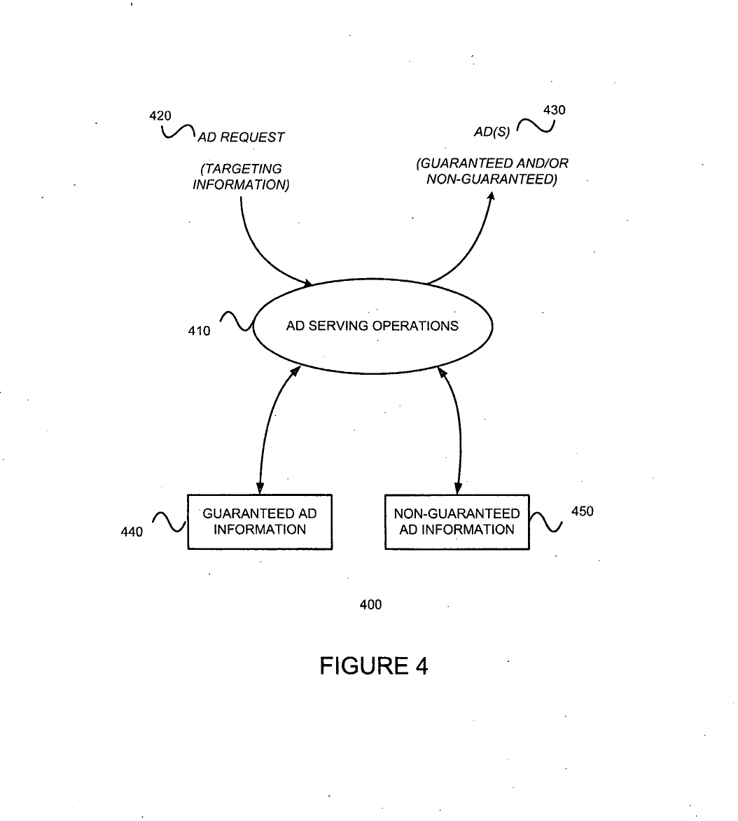

FIG. 3 is a bubble diagram illustrating exemplary advertising guarantee generation and/or checking operations 300 that might be performed in an embodiment consistent with the present invention, as well as information that may be used and/or generated by such operations. Generally, advertiser 320 may provide request information 325 including desired serving constraints (e.g., one or more keywords) and conditions (e.g., time period, budget, etc.) to the guarantee generation and/or checking operations 310. The checking operations 310 may include (or directly or indirectly interact with) forecasting operations 340, traffic projection operations 350, and/or market projection operations 355. The forecasting operations may establish an estimated and/or market value of the requested serving constraints. The traffic projection operations 350 may use historical traffic information 345 regarding the advertiser specified ad constraints and conditions. The market projection operations 355 may use historical offer information 360 regarding the advertiser specified ad constraints and conditions. Using the information provided by the forecasting operations 340, the guarantee generation and/or checking operations 310 may determine if the advertiser request can be guaranteed given the desired constraints and conditions. The operations 310 then provide a reply (e.g., yes, no, alternatives, yes with price, etc.) 330 to the advertiser 320. If the advertiser's request is accepted, or if the reply includes an alternative guarantee and the advertiser responds with their acceptance, then the guaranteed ad information 370, including or otherwise associated with the constraints and conditions (e.g., time period, total cost, target keywords, etc.), may be stored for use in future ad serving, in a manner consistent with the present invention.

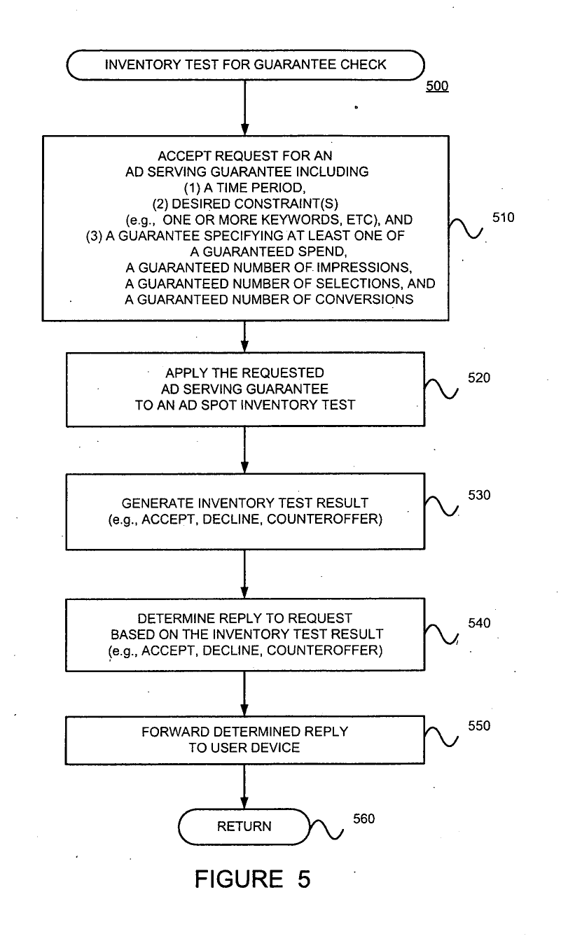

FIG. 4 is a bubble diagram illustrating exemplary ad serving operations 410, performed in a manner consistent with the present invention, as well as information that may be used and/or generated by such operations. The ad request 420 including any targeting information (e.g., one or more keywords) is forwarded to the ad serving operations 410. The ad serving operations 410 may evaluate which ads are eligible to be served using guaranteed ad information 440 and non-guaranteed ad information 450. Generally, ads will be “eligible” if their serving constraints are met by the targeting information included in the ad request 420 of the eligible ads. The ad serving operations 410 may serve one or more (e.g., based a number desired indicated in the request 420) of the eligible ads using arbitration rule(s). Thus, a Webpage may be served with (a) guaranteed ads only, (b) non-guaranteed ads only, or (c) a mix of both guaranteed and non-guaranteed ads. There are other factors (e.g., revenue and inventory projections, quality targets, etc.) that may be associated with not serving an ad request or a particular ad (guaranteed or non-guaranteed) that may be determined by ad serving operations 410.

§4.3.1 Exemplary Methods

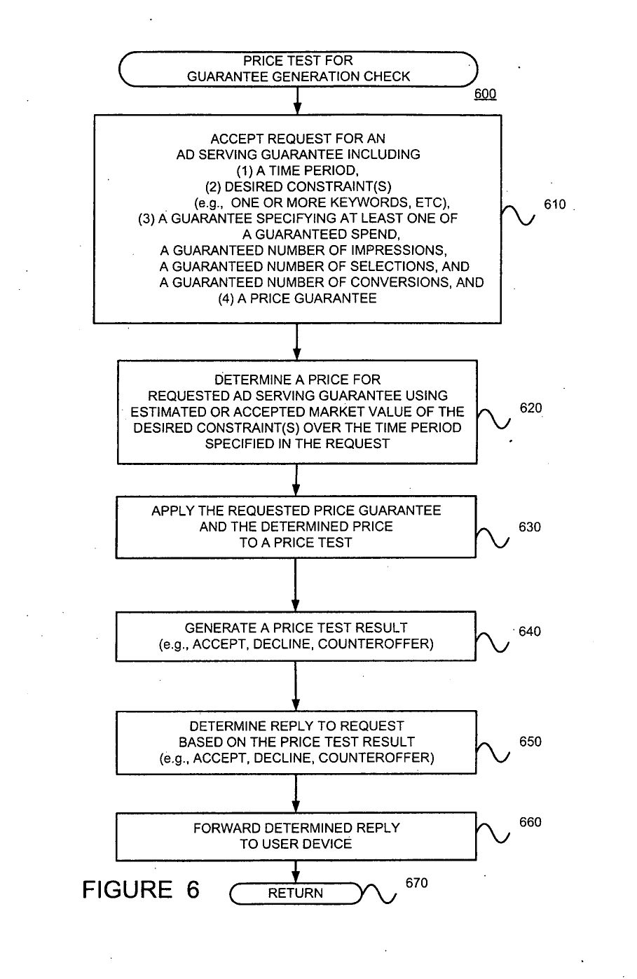

FIG. 5 is a flow diagram illustrating an exemplary method 500 for performing an inventory test for an ad guarantee check 500, in a manner consistent with the present invention. A request for an ad serving guarantee is accepted. (Block 510) The request may include one or more desired constraints (e.g., one or more keywords, a desired position or prominence, a geographic target, etc.) and conditions. The conditions specified may include a time period over which the guarantee is to apply, and a guarantee specifying at least one of (a) a guaranteed spend, (b) a guaranteed number of impressions, (c) a guaranteed number of selections, and (d) a guaranteed number of conversions.

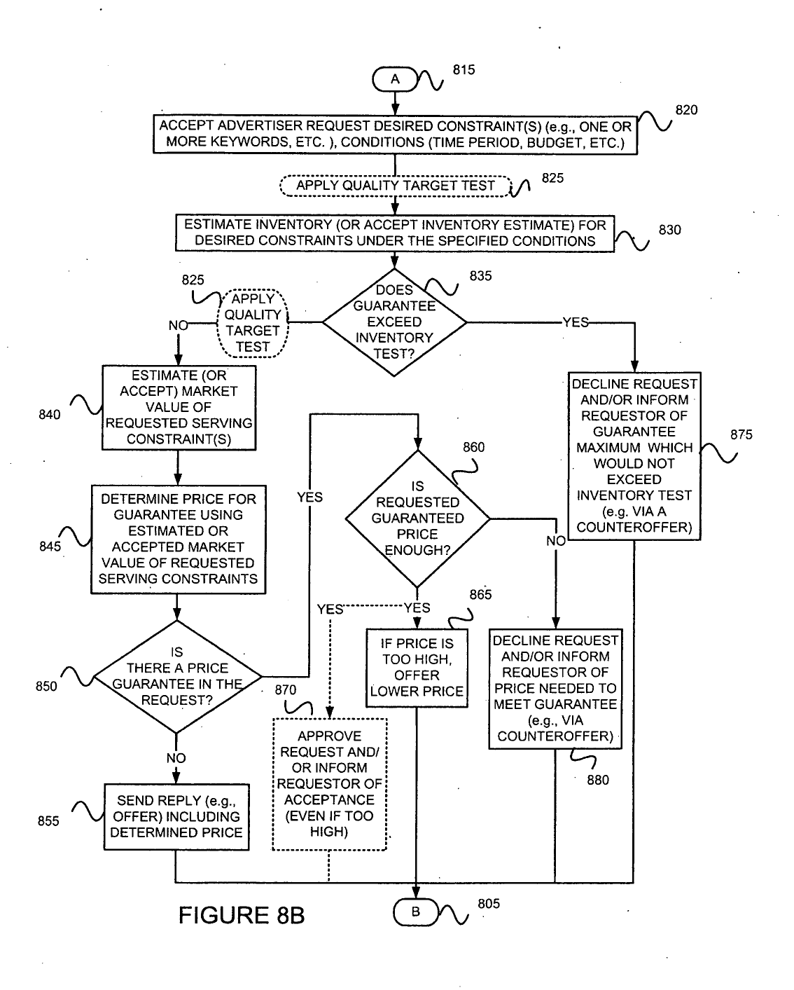

Subsequently, the requested ad serving guarantee, including the specified constraints and conditions, may be applied to an ad spot inventory test. (Block 520) This test may compare the sought guarantee with the present ad spot inventory to ensure that the requested ad serving guarantee can be met, or met with a predetermined margin, to generate an inventory test result. (Block 530) An exemplary ad spot inventory test is described below with reference to FIG. 8B. The inventory test result may be an acceptance of the ad serving guarantee request, a decline of the ad serving guarantee request, or a counteroffer. A counteroffer may indicate alternative constraints (e.g., one or more different and/or additional keywords), and/or conditions (e.g., a different time period, a different guaranteed spend, etc.). After the inventory test results have been generated, a reply to the ad serving request guarantee is determined based on the test results. (Block 540) The reply may be an acceptance of the ad serving guarantee request, a decline of the ad serving guarantee request, or a counteroffer, as just mentioned. (Block 540)

After the reply to the ad serving guarantee request is determined, it is forwarded to a user device (e.g., browser facility, email facility, PDA, etc.). (Block 550) The method 500 is then left. (Node 560)

Referring back to block 540, if the requested price guarantee is accepted by the ad spot inventory test, the reply might include for each of the one or more serving constraints (e.g., keywords), at least one of (a) a guaranteed fixed price per impression, (b) a guaranteed fixed price per selection, and (c) a guaranteed fixed price per conversion.

Alternatively, or in addition, the reply might include, for the specified time period, at least one of (a) a guaranteed number of impressions, (b) a guaranteed number of ad selections, and (c) a guaranteed number of ad conversions.

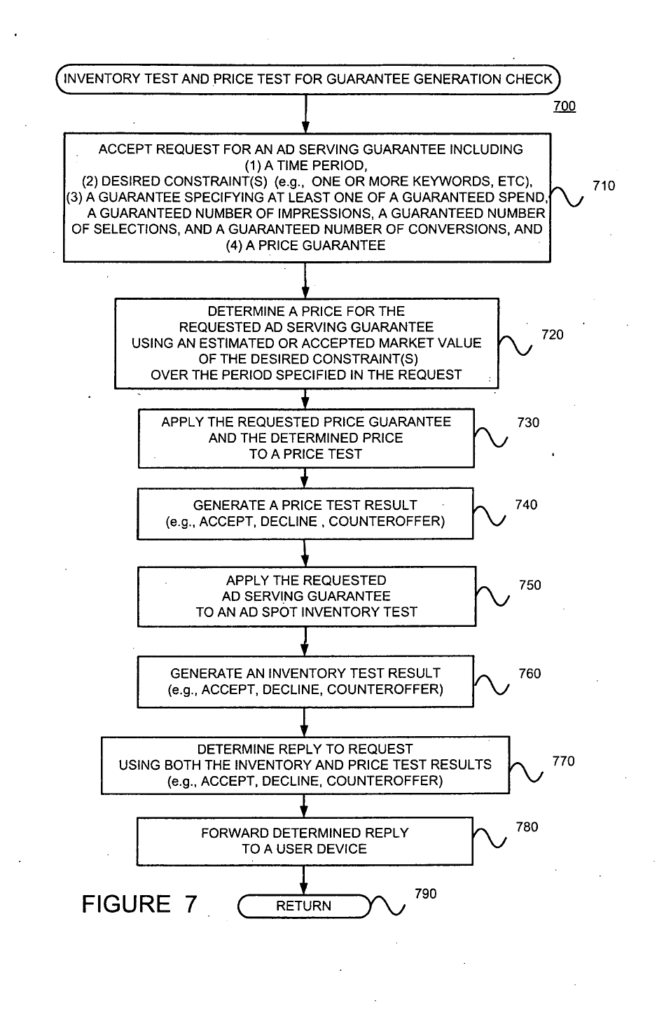

FIG. 6 is a flow diagram illustrating an exemplary method 600 for performing a price test for an advertising guarantee request, in a manner consistent with the present invention. The request for an ad serving guarantee is accepted. (Block 610) The request might include at least one ad serving desired constraint (e.g., one or more keywords, a desired position or prominence, a geographic target, etc.). Additionally, the request might include conditions such as a time period and a guarantee specifying at least one of (a) a guaranteed spend, (b) a guaranteed number of impressions, (c) a guaranteed number of selections and (d) a guaranteed number of conversions, along with a price guarantee.

A price for the requested ad serving guarantee may be determined using an estimated or an accepted market value (e.g., projections based on historical offer information) of the desired constraints over the time period specified in the request. (Block 620) Additionally, projections based on historical ad serving results, for exact or similar ad spot constraints and serving parameters, may involve using futures pricing using known methods (e.g., methods employed in futures contracts).

Subsequently, the requested price guarantee and the determined price, may be applied to a price test. (Block 630) An exemplary price test consistent with the present invention is described below with reference to FIG. 8B.

The price test result may be an acceptance of the ad serving guarantee request, a decline of the ad serving guarantee request, or a counteroffer. A counteroffer may indicate alternate constraints (e.g., one or more different and/or additional keywords), and/or conditions (e.g., a different time period, a different guaranteed spend, a different price guarantee, etc.) (Block 640)

After the price test result has been generated, a reply to the requested ad serving guarantee is determined. (Block 650) The reply may consist of an acceptance of the requested ad serving guarantee, a decline of the requested ad serving guarantee, or a counteroffer. A counteroffer may indicate alternative constraints (e.g., one or more different and/or additional keywords), and/or conditions (e.g., a different time period, a different guaranteed spend, a different price, etc.). If the request was accepted, the reply might include for each of the one or more serving constraints (e.g., keywords), at least one of (a) a guaranteed fixed price per impression, (b) a guaranteed fixed price per selection, and (c) a guaranteed fixed price per conversion.

Alternatively, or in addition, the reply might include, for example, for the specified time period, at least one of (a) a guaranteed number of impressions, (b) a guaranteed number of ad selections, and (c) a guaranteed number of ad conversions. After the reply to the ad serving guarantee request is determined, it is forwarded to a user device (e.g., browser facility, email facility, PDA, etc.). (Block 660) The method 600 is then left. (Node 670)

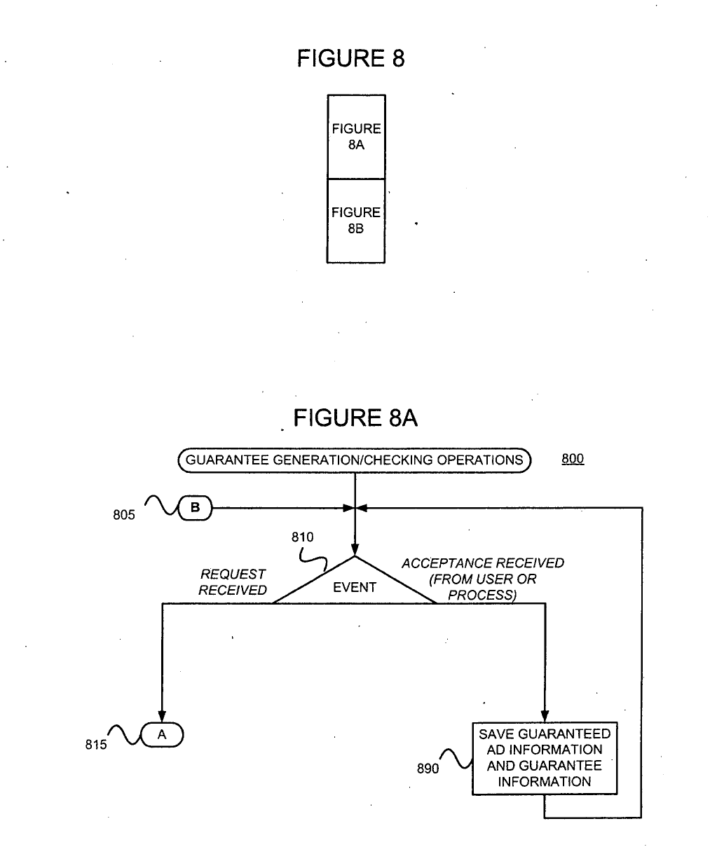

FIG. 7 is a flow diagram illustrating an exemplary method 700 for performing both an inventory test and a price test for an advertising guarantee request, in a manner consistent with the present invention. Blocks 710-740 of the method 700 are similar to blocks 610-640 of the method 600 of FIG. 6. The request for an ad serving guarantee is accepted. (Block 710) The request might include as least one ad serving desired constraint (e.g., one or more keywords, a desired position or prominence, a geographic location, etc.). Additionally, the request might include conditions such as a time period and a guarantee specifying at least one of (a) a guaranteed spend, (b) a guaranteed number of impressions, (c) a guaranteed number of selections and (d) a guaranteed number of conversions, along with a price guarantee.

A price for the requested ad serving guarantee may be determined using an estimated or an accepted market value (e.g., projections based on historical offer information) of the desired constraints over the time period specified in the request. (Block 720)

Subsequently, the requested price guarantee and the determined price, may be applied to a price test. (Block 730) An exemplary price test consistent with the present invention is described below with reference to FIG. 8B.

The price test result may be an acceptance of the ad serving guarantee request, a decline of the ad serving guarantee request, or a counteroffer. A counteroffer may indicate alternate constraints (e.g., one or more different and/or additional keywords), and/or conditions (e.g., a different time period, a different guaranteed spend, a different price guarantee, etc.). (Block 740)

Further, blocks 750 and 760 of the method 700 are similar to Blocks 520 and 530, respectively, of the method 500 of FIG. 5. The requested ad serving guarantee, including the specified constraints and conditions, may be applied to an ad spot inventory test. (Block 750) This test may compare the sought guarantee with the present ad spot inventory to ensure that the requested ad serving guarantee can be met, or met with a predetermined margin (this may include, for example, an inventory and/or price margin), to generate an inventory test result. (Block 760) An exemplary ad spot inventory test is described below with reference to FIG. 8B.

The inventory test result may be an acceptance of the ad serving guarantee request, a decline of the ad serving guarantee request, or a counteroffer. A counteroffer may indicate alternate constraints (e.g., one or more different and/or additional keywords), and/or conditions (e.g., a different time period, a different guaranteed spend, different serving parameters, etc.).

After both the price test and inventory test results have been generated, a reply to the ad serving request guarantee is determined using both of the test results. (Block 770) The reply may include an acceptance of the requested ad serving guarantee, a decline of the requested ad serving guarantee, or a counteroffer. A counteroffer may indicate alternate constraints (e.g., one or more different and/or additional keywords), and/or conditions (e.g., a different time period, a different guaranteed spend, a different price, etc.).

Referring back to the block 770, the reply to the requested ad guarantee may indicate an acceptance only if both the price test result, and the inventory test result, pass. If either the price test result is a “fail” or the inventory test result is a “fail,” then the requested ad guarantee is declined (or a counteroffer is made).

If the request is accepted, the reply to the requested ad guarantee might include for each of one or more serving constraints (e.g., keywords), at least one of (a) a guaranteed fixed price per impression, (b) a guaranteed fixed price per selection and (c) a guaranteed fixed price per conversion.

Alternatively, or in addition, the reply might include, for the specified time period, at least one of (a) a guaranteed number of impressions, (b) a guaranteed number of ad selections and (c) a guaranteed number of ad conversions. After the reply to the ad serving guarantee request is determined, it is forwarded to a user device (e.g., browser facility, email facility, PDA, etc.). (Block 780) The method 700 is then left. (Node 790)

FIG. 8, which includes FIGS. 8A and 8B, is a flow diagram illustrating an exemplary method 800 for generating and/or checking advertising guarantees in a manner consistent with the present invention. Referring to FIG. 8A, different branches of the method 800 may be executed upon the occurrence of different events. (Block 810) Specifically, if an ad guarantee request is received, the method 800 will proceed to block 820 of FIG. 8B, via node 815. The request for an ad serving guarantee, which includes at least one desired ad serving constraint (e.g., one or more keywords) and one or more conditions (such as a time period), and a guarantee specifying at least one of (a) a guaranteed spend, (b) a guaranteed number of impressions, (c) a guaranteed number of selections and (d) a guaranteed number of conversions, along with a price guarantee, is accepted. (Block 820)

The method 800 may then proceed to estimate the ad spot inventory (or an inventory estimate may simply be accepted) for desired constraints under the specified conditions. (Block 830) The percentage of the ad spot inventory available may be limited to some predetermined maximum. Thus, an inventory test may determine if the ad guarantee would exceed the maximum allowed percentage of the estimated ad spot inventory. (Block 835) An exemplary ad spot inventory test may involve forecasting the number of ad spots expected for the specific time period that meet at least one of the ad serving constraints specified, and then accepting a predetermined maximum percentage of those qualifying ads for reservation. The exemplary inventory test may then determine whether the predetermined maximum percentage of ads would be exceeded due to one of (a) a requested guaranteed spend, (b) a requested guaranteed number of impressions, (c) a requested guaranteed number of selections, and (d) a requested guaranteed number of conversions. If the maximum allowed percentage of the ad spot inventory is not exceeded, the inventory test would pass. Alternatively, the inventory test may determine future inventory using a variable schedule to determine whether the predetermined maximum percentage of ads would be exceeded, thereby allowing greater flexibility in ad serving. For example, the current month may allow for 60% of the inventory to be reserved, followed by 30% the next month and 20% in the third month.

If the predetermined maximum percentage has been exceeded, then the inventory test fails and a decline of the requested ad guarantee, and possibly a counteroffer, may be generated. (Block 875) A counteroffer may contain alternative guarantee maximum information that would satisfy the ad spot inventory test. The method 800 then returns to the event block 810 in FIG. 8A. (via node B 805)

Referring back to block 835, if the ad guarantee request passes the inventory test, then an estimate of the market value for the requested ad serving guarantee given the desired constraints and conditions is determined or accepted. (Block 840) Further, a price may be determined for the requested ad guarantee using an estimated and/or accepted market value given the desired constraints and conditions. (Block 845) This may be done using forecasting operations and/or market projection operations. (Recall 340 and 355 of FIG. 3.) These projections may use historical offer information for the serving constraints specified. (Recall 360 of FIG. 3.)

Referring to decision block 850, it is determined if there is a price guarantee specified in the ad guarantee request. If a price guarantee is not specified, then a reply is returned in the form of an offer indicating the determined price. (Block 855) The method 800 then returns to the event block 810 FIG. 8A (via node B 805). Referring once again to decision block 850, if a price guarantee is specified in the ad guarantee request, then whether or not the requested guaranteed price is sufficient may be determined. (Block 860) If the requested guaranteed price is sufficient, then a reply may indicate that the advertiser can pay a lower price, along with an indication of an acceptable lower price. (Block 865) Thus, the reply might be considered a counteroffer, or just an acceptance at a lower price. As an alternative, if the requested guarantee price is sufficient, then a reply may be returned indicating an acceptance of the requested guarantee at the requested price. (Block 870) The method 800 then returns to the event block 810 in FIG. 8A (via node B 805).

As can be appreciated from blocks 865 and 870, the reply to a requested guarantee price may include, for each of one or more serving constraints (e.g., keywords), at least one of (a) a guaranteed fixed price per impression, (b) a guaranteed fixed price per selection, and (c) a guaranteed fixed price per conversion. Alternatively, or in addition, the reply might include, for the specified time period, at least one of (a) a guaranteed number of impressions, (b) a guaranteed number of ad selections, and (c) a guaranteed number of ad conversions.

Referring back to block 860, if the requested guaranteed price is insufficient, then the ad guarantee request is declined. (Block 880). A counteroffer may be included in the reply. The counteroffer may include an alternate price that would pass the price guarantee test. The method 800 returns to the event block 810 in FIG. 8A (via Node B 805).

Referring back to decision block 835, in some embodiments consistent with the present invention, adjustments to the predetermined maximum allowed percentage of inventory may be made. Further, rather than providing a single fixed reservation percentage cutoff (e.g., at 65%), other exemplary inventory tests consistent with the present invention could use additional rules (e.g., different price premiums at different “tiers” of guaranteed percentages of ad spot inventor) and/or formulas (e.g., price premium is a function of guaranteed percentage of ad spot inventor). For example, such an embodiment might charge different price premiums at different percentages of all ad spot inventory, with higher premiums being charged for guaranteeing higher percentages of the available ad spot inventory.

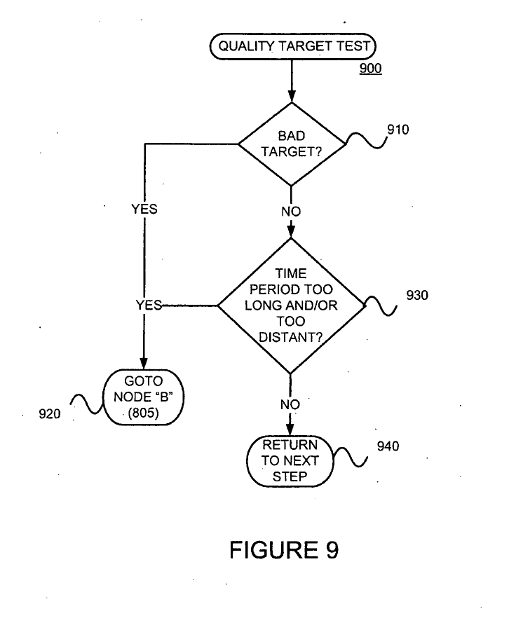

As shown by nodes 825 of FIG. 8B, the desired constraints and conditions specified in the guarantee request may be evaluated in order to determine the quality of the constraints (also referred to as “targets”). FIG. 9 is a flow diagram of an exemplary method 900 that may be used to determine if one or more of the “targets” specified in the request is of an acceptable “quality”, in a manner consistent with the present invention. Establishing a quality of a target may consider various factors (e.g., pricing uncertainty, delivery uncertainty, unacceptable words, etc.) in order to generate an acceptable guarantee. As shown, if the target specified is deemed unacceptable, the method 900 is left and processing returns to node B 805 of FIG. 8A via node 920. (Block 910) If the target is acceptable, the time period specified in the guarantee request may be evaluated. (Block 930) Determining whether the time period is acceptable may consider various factors (e.g., too short a time period, too long a time period, too distant a time period, etc.) If the time period specified is deemed unacceptable, the method 900 is left and processing returns to node B 805 of FIG. 8A via node 920. (Block 930) If, on the other hand, the time period specified is acceptable, the method 900 is left and processing returns to the next act (Block 830 or 840) of FIG. 8B, via node 940.

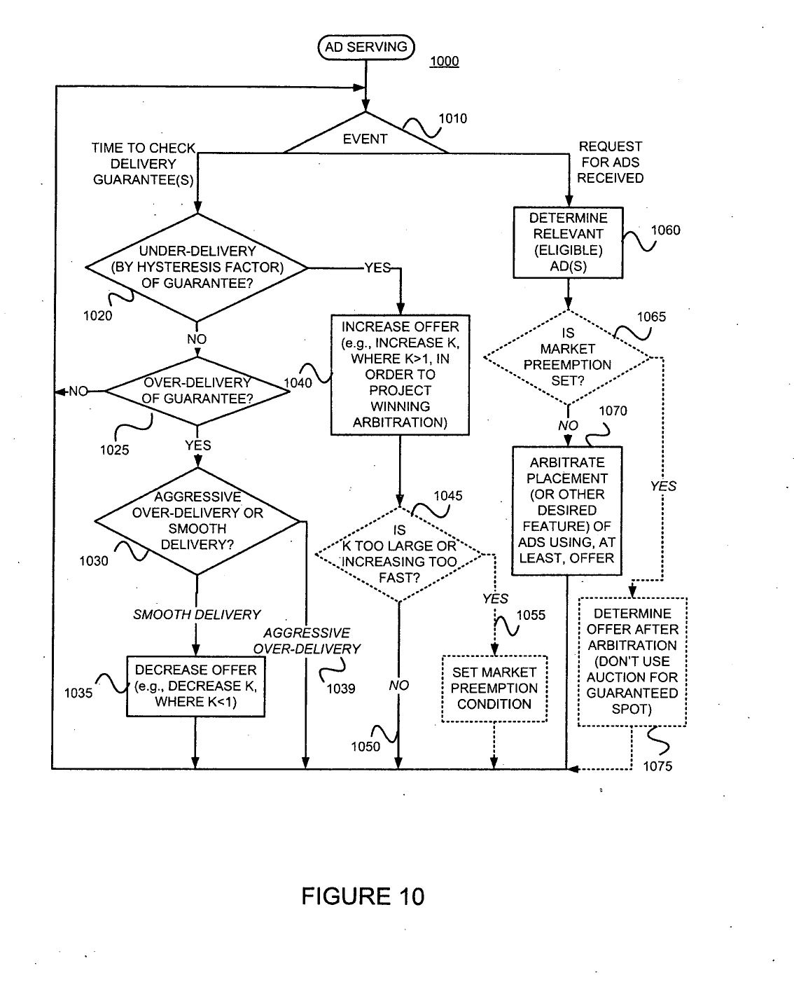

FIG. 10 is flow diagram illustrating an exemplary method 1000 for performing ad serving operations, in a manner consistent with the present invention. Different branches of the method 1000 may be executed upon the occurrence of different events. (Block 1010) For example, the left branch of the method 1000 is performed if it is time to check delivery guarantees, while the right branch of the method 1000 is performed if a request for ads is received.

A periodic check of the delivery guarantee status may determine if under-delivery of the ads has occurred (that is, it is projected that too few ads will be served (or selected, or converted), and/or too little money will be spent, to meet the guarantee). (Block 1020) Under-delivery may occur when at least one ad is not being sufficiently served with respect to its guaranteed serving reservation. If under-delivery has not occurred, it may be determined whether over-delivery is expected. (Block 1025) If not, the method 1000 branches back to event block 1010. If over-delivery is expected, the method 1000 continues to decision block 1030.

At decision block 1030, a previously determined delivery method (e.g., smooth delivery, aggressive over-delivery) may be used to control future ad serves. (Block 1030) If smooth delivery was determined or selected, then the price offer may be reduced by an adjustment factor. (Block 1035) The value of the adjustment factor may be decreased to less than 1, which may permit the ad to participate in future arbitrations at a lower offer (e.g., (a) a decreased offer per impression, (b) a decreased offer per selection, (c) a decreased offer per conversion, etc.) This will effectively decrease the delivery of the currently over-delivered ad. The method 1000 then returns to the event block 1010.

Referring back to decision block 1030, if aggressive over-delivery was selected or determined, the offer associated with the ad may be unchanged, thereby allowing over-delivery to continue. That is, there may be policy of allowing the ad serving guaranteed to be satisfied early in the specified time period. The method 1000 then returns to the event block 1010.

Note that after the ad serve guarantee(s) has been satisfied, additional ads may be served through arbitration subject to the current market conditions.

Referring back to decision block 1020 , in the event of under-delivery, the price offer is automatically increased (e.g., (a) an increased offer per impression, (b) an increased offer by selection, (c) an increased offer per conversion, etc.) by an adjustment factor (e.g., adjustment factor greater than 1) in order to project winning future arbitrations. (Block 1040) The method 1000 may then return to event block 1010. Note, however, that if the offer is adjusted too infrequently and/or too slowly (e.g., by too small an amount) the ad might be chronically under-delivered. Optional blocks 1045 and 1055 may be performed in order to address such a possibility. Specifically, if the adjustment factor becomes too large (e.g., greater than a predetermined maximum), and/or the rate of the increase becomes greater than a predetermined maximum, then a “market preemption” condition may be set (Blocks 1045 and 1055) before the method 1000 continues back to event block 1010. As will be appreciated after reading the description of blocks 1065 and 1075 below, “the market preemption” condition modifies future arbitrations involving the ad, thereby ensuring serving of the ad in order to meet its guarantee. Referring back to block 1045, if the adjustment factor is not too large and/or increasing too fast, then the method 1000 may simply continue back to event block 1010.

Referring back to event block 1010, if a request for one or more ads is received, relevant ads (e.g., eligible ads having constraints meeting those specified in the request) are determined. (Block 1060) The set of eligible ads may include (a) only ads having a guarantee serving reservation (Recall, e.g., 440 of FIG. 4.), (b) ads without any serving guarantee (Recall, e.g., 450 of FIG. 4.), or (c) both types of ads. Each ad of the set of eligible ads includes at least one of (a) an offer per impression, (b) an offer per selection, and (c) an offer per conversion.

An arbitration process is then used to determine the set of ad(s) to serve from the set of eligible ads (assuming that there are more eligible ads than available ad spots) and/or how (e.g., placement order) the ads are to be served. (Block 1070) The arbitration considers, at least, an offer associated with each ad. Recall that the offers of ads subject to a guarantee might have been adjusted. (Recall, e.g., blocks 1035 and 1040). For example, the offer might be multiplied by the factor K. Specifically, in such an example, if the K>1, the offer will be increased, while if K<1, the offer will be decreased. The method 1000 then returns to the event block 1010.

In at least some embodiments consistent with the present invention, whether or not “market preemption” has been set (Recall, e.g., block 1055) is determined. (Block 1065). If not, the method 1000 simply proceeds to block 1070, already described above. If, on the other hand, the market preemption condition is set, then the offer for at least one of (a) offer per impression, (b) offer per selection, and (c) offer per conversion of the guaranteed, but under-delivered ad is set after the arbitration order to ensure serving of the ad. (Block 1075) The method 1000 then returns to the event block 1010.

Referring back to event block 1010, delivery status might be checked on demand. Alternatively, or in addition, the delivery guarantee status might be checked periodically (e.g., hourly, daily, weekly, etc.). Alternatively, or in addition delivery status might be checked when the system is under a relatively light load.

Although not shown, if the “market preemption” condition is set it can be reset (i.e., removed) under certain conditions. For example, when checking delivery guarantees, if over-delivery occurs, or if K falls below the critical level, then “market preemption” might no longer be appropriate, and may therefore be removed.

§4.3.2 Exemplary Apparatus

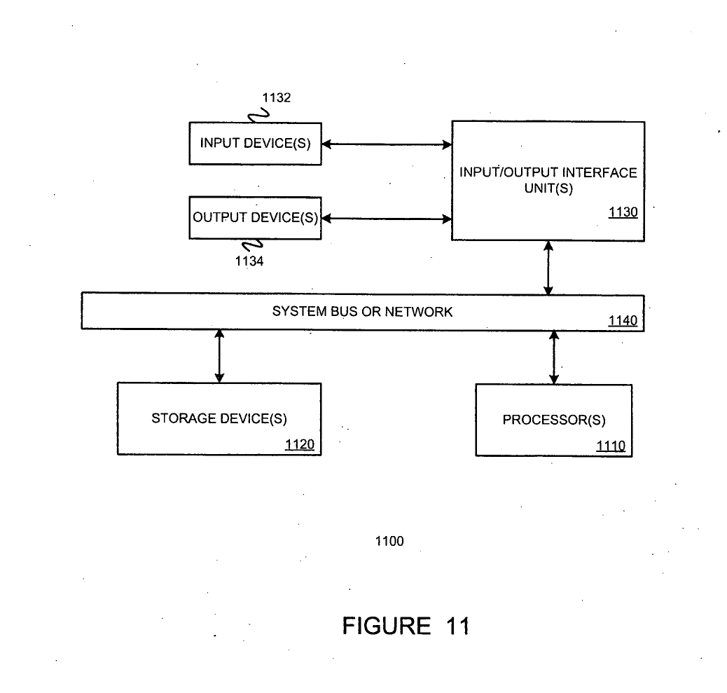

FIG. 11 is a block diagram of apparatus 1100 that may be used to perform at least some operations, and store at least some information, in a manner consistent with the present invention. The apparatus 1100 may include one or more processors 1110, one or more input/output interface units 1130, one or more storage devices 1120, and one or more system buses and/or networks 1140 for facilitating the communication of information among the coupled elements. One or more input devices 1132 and one or more output devices 1134 may be coupled with the one or more input/output interfaces 1130.

The one or more processors 1110 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. For example, one or more software modules, when executed by a processor, may be used to perform one or more of the operations and/or methods of FIGS. 1-10. At least a portion of the machine executable instructions may be stored (temporarily or more permanently) on the one or more storage devices 1120 and/or may be received from an external source via one or more input interface units 1130.

In one embodiment, the machine 1100 may be one or more conventional personal computers or servers. In this case, the processing units 1110 may be one or more microprocessors. The bus 1140 may include a system bus. The storage devices 1120 may include system memory, such as read only memory (ROM) and/or random access memory (RAM). The storage devices 1120 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1132, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1110 through an appropriate interface 1130 coupled to the system bus 1140. The output devices 1134 may include a monitor or other type of display device, which may also be connected to the system bus 1140 via an appropriate interface. In addition to (or instead of) the monitor, the personal computer may include other (peripheral) output devices (not shown), such as speakers and printers for example.

The operations described above may be performed on one or more computers. Such computers may communicate with each other via one or more networks, such as the Internet for example. Referring back to FIG. 3 for example, the various operations and information may be embodied by one or more machines 1100.

§4.3.3 Refinements, Alternatives and Extensions

In some embodiments consistent with the present invention, once a guarantee reservation is satisfied, additional ad serving of the ad may occur at the established market price.

An alternative guarantee may specify match types (e.g., exact, phrase, broad) for the serving constraints (e.g., keywords, phrases, language, location, time, etc.). Although a guarantee might specify a time period and a spend, an alternative guarantee might specify one or more of a position (header, footer, top spot in margin, at least the second spot in margin, etc.) of the ad, a document on which the ad is to be served, a Website on which the ad is to be served, etc., instead of, or in addition to, the time period and/or the spend.

Referring back to FIG. 9, although target quality was checked, other quality factors (e.g., minimum ad performance, determined policy acceptance) may be checked instead, or in addition.

Referring back to FIG. 10, in some embodiments consistent with the present invention, (a) the amounts of increases and/or decreases made to the adjustment factor, (b) limits on the rate of the increase and/or decrease made to the adjustment factor, and/or (c) the maximum adjustment factor may be fixed, while in other embodiments consistent with the present invention, such at least some of such values may be varied.

Referring back to FIG. 10, in some embodiments consistent with the present invention, statistical techniques and historical information may be used to determine the actual costs incurred to guarantee ad serving, and may effect (a) the amounts of increases and/or decreases made to the adjustment factor, (b) limits on the rate of the increase and/or decrease made to the adjustment factor, and/or (c) the maximum adjustment factor limits.

In some embodiments consistent with the present invention, the ad serving request guarantee may also be expanded to include offline advertising (e.g., offline radio, print, television, etc.), or a combination of offline and online advertising.

In some embodiments consistent with the present invention, the ad serving entity may require that guarantees may not be resold (e.g., to avoid potential quality problems, to avoid potential market domination problems, etc.).

In some embodiments consistent with the present invention, consequences (e.g., a financial penalty, specified damages, etc.) of failing to meet a guarantee may be specified.

§4.4 Example of Operations in an Exemplary Embodiment Consistent with the Present Invention

The following are illustrative examples of operations in an exemplary embodiment consistent with the present invention. They are not intended to be exhaustive or to limit the present invention to the precise methods or particular values disclosed. These examples may be repeated for varying constraints and conditions.

§4.4.1 Determining an Ad Guarantee

This example will illustrate a way in which an ad guarantee might be generated, in a manner consistent with the present invention. Suppose an advertiser submits a request for an ad serving guarantee with the keywords “Tennis Rackets”, “Tennis” and “Wilson”. The conditions provided are a one-month time period from Dec. 1, 2007-Dec. 31, 2007 and a guaranteed spend of $100,000.00.

Suppose that both the price test and the inventory test described in FIGS. 7 and 8 are applied. Suppose further that the requested guarantee is forecast to use 15% of all expected ad spots for those keywords over the desired period, and that the inventory test is that no more than 65% of all ad spot inventory be subject to guarantees. Assuming there are no other pertinent guarantees existing, the inventory test is passed. As discussed above with reference to 835 of FIG. 8, rather than providing a fixed reservation percentage cutoff (e.g., at 65%), other exemplary inventory tests consistent with the present invention could use additional rules (e.g., different price premiums at different “tiers” of guaranteed percentages of ad spot inventor) and/or formulas (e.g., price premium is a function of guaranteed percentage of ad spot inventor). For example, such an embodiment might charge different price premiums at different percentages of all ad spot inventory, with higher premiums being charged for guaranteeing higher percentages of the available ad spot inventory.

Since the request does not include a price guarantee sought, a reply including a price for the guarantee determined using estimated market values of the requested constraints is provided in a reply and sent to the requesting advertiser. (Recall Blocks 840, 845, 850 and 855 of FIG. 8B.) An example of a reply might be a guaranteed fixed price per selection of “Tennis Rackets”=$1.00, “Tennis”=$0.35, “Wilson”=$1.75, along with a guarantee spend of $100,000 for the month of December 2007 for these keywords.

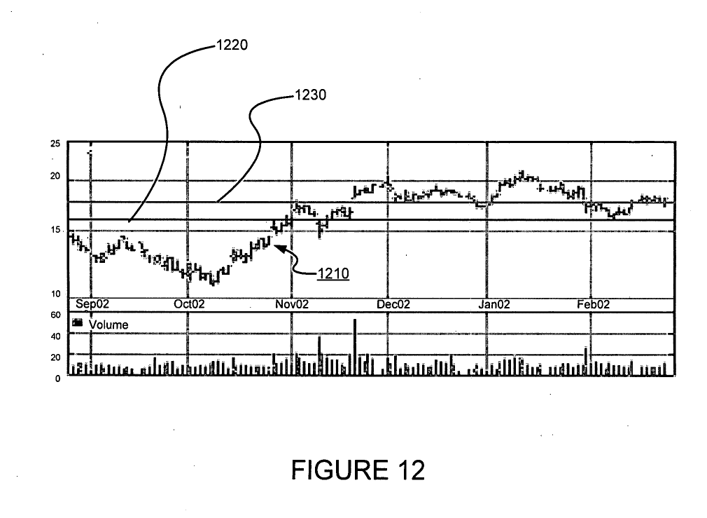

Referring to FIG. 12, the marks 1210 indicate the spot market price (e.g., observed price per selection) of an ad served subject due to its matching a serving constraint (e.g., the term “Wilson”). The line 1220 indicates the average price over the period and the line 1230 indicates a premium price. The reply price might include the premium price 1230, or a price derived from the premium price. The premium to the average price serves to mitigate the risk to the ad serving entity of predicting too low of a price for a guarantee. That is, the difference between the lines 1220 and 1230 can be thought of as a “risk buffer.” The area between the spot market price 1210 and the premium price 1230 when the premium price 1230 is greater than the spot market price 1210 reflects a surplus made by the ad serving entity. Similarly, the area between the spot market price 1210 and the premium price 1230 when the premium price 1230 is less than the spot market price 1210 reflects a deficit incurred by the ad serving entity. The surplus can be thought of as insurance premiums being paid to the ad serving entity, while the deficit can be thought of as insurance losses being incurred by the ad serving entity.

When predicting or estimating spot market prices for some future period of time, the greater the premium 1230 to the (expected) average 1220 for the relevant period, the less the risk to the ad serving entity. Indeed, the ad serving entity is expected to (and might actually) make more than it would have without the guarantee. However, the greater the premium 1230 to the (expected) average 1220 for the relevant time period, the less attractive the guarantee is to the advertiser.

If an acceptance is received from the advertiser, then the guaranteed ad information and the guarantee information is saved. (Recall, e.g., 810 and 890 of FIG. 8A.) In this example, the request met the inventory test and did not specify price guarantee(s) sought. Suppose that the advertiser rejected the reply including the determined prices, perhaps indicating that the prices were too high. In this case, a counteroffer including alternate constraints (e.g., “Tennis Rackets”, “Strings” and “Grips”) and conditions (e.g., Nov. 1, 2007-Dec. 31, 2007) for an ad serving guarantee request might be offered, in a manner consistent with the present invention. For example, assuming the keywords previously mentioned, a sample counteroffer result could be “Tennis Rackets”=$0.90/selection, “Tennis”=$0.35/selection, “String”=$0.10/selection and “Grips”=$0.020/selection along with a guarantee spend of $100,000 over the extended time period.

In an alternative embodiment consistent with the present invention, a reply might be a guaranteed fixed price per selection of $0.80, along with a guarantee spend of $100,000 for the month of December for any one of the plurality of keywords specified. This would result in 125,000 guaranteed selections (e.g., $100.000/$0.80=125,000), but any of keywords could be used to satisfy the guarantee.

In another alternative embodiment consistent with the present invention, a reply could be a guaranteed fixed price per conversion of $1.25, along with a guarantee spend of $100,000 for the month of December for any of the plurality keywords specified. This would result in 80,000 guaranteed conversions per month (e.g., $100.000/$1.25=80,000) for any of the plurality of keywords.

§4.4.2 Ad Serving Using a Reservation

This example illustrates ad serving, in a manner consistent with the present invention. Assume that the accepted guarantee is for fixed price per selection of $0.80, along with a guarantee spend of $100,000 per month for any one of the plurality of keywords. During the ad serving process, a periodic check of the ad delivery guarantee status may determine if an ad having a guarantee is not being sufficiently served to meet its guarantee (i.e., whether there is under-delivery). Suppose the check is performed daily.

Suppose on Dec. 2, 2007 that under-delivery has not occurred. In fact, suppose that over-delivery is occurring such that the guarantee of $100,000 spend is expected to be met by Dec. 20, 2007. Assume that aggressive over-delivery is set. In this case, the offers/selection associated with the keywords is unchanged. (Recall, e.g., 1020, 1025 and 1030 of FIG. 10.)

Suppose the keyword(s) associated with the guarantee become increasingly popular and subject to increasingly higher offers by other advertisers. Suppose that by the Dec. 15, 2007, under-delivery occurs. In this case, it is expected that the ad will have to offer $1.05 for the keywords for the guarantee to be met. In this case, K set to 1.35 ($0.80*1.35=$1.05=guaranteed price*K=the price thought to be needed to satisfy delivery guarantee). (Recall, e.g., 1020 and 1040 of FIG. 10.) Periodic checks of the ad delivery (e.g., under-delivery, over-delivery, etc.) may result in further adjustments to the value of K. For example, referring to the current example, if under-delivery ceases (e.g., if meeting the ad serving entity “caught up” on meeting the guarantee faster than expected), then the value of K may be set to 0.90 in order to satisfy a smooth delivery guarantee, and may reduce the price premiums.

Suppose further that the keyword(s) associated with the guarantee become so popular that the daily adjustments cannot keep pace with the increasingly higher offers by other advertisers. In this case, market preemption might be set to “force” the ad to be served. (Recall, e.g., 1020, 1040, 1045 and 1055 of FIG. 10.)

At the end of the relevant period, the guarantee spend of $100,000 should have been met. If the premium fixed price per selection of $0.80 for the keywords was set properly, the ad serving entity should have received a premium over what would have been necessary (e.g., $0.73 per selection) to have meet the guarantee spend. Even if some amount between $0.73 and $0.80 per selection would have been necessary to meet the guarantee spend, the ad serving entity would have been better off, or at least no worse off, than if it had not made the guarantee. If, however the premium fixed price per selection of $0.80 was too low—that is, if it was necessary to actually bid more than $0.80 per selection to meet the guarantee—then the ad serving entity would be worse off than if it had not made the guarantee.

### §4.5 CONCLUSIONS

As can be appreciated from the foregoing, the embodiments consistent with the present invention advantageously allow an ad serving system to provide guarantees to advertisers.

1-42. (canceled)

43. A computer-implemented method, comprising:
identifying, by one or more processors, a set of eligible ads that are eligible for delivery to a user device, including:
identifying, for inclusion in the set of eligible ads, a guaranteed ad that is required to be presented on third-party resources at least at a specified number of times; and
identifying, for inclusion in the set of eligible ads at least one non-guaranteed ad;
determining, for the guaranteed ad, a baseline offer based on a total amount that will be paid for presentation of the guaranteed ad the specified number of times on the third party resources;
determining an actual delivery level that describes a number of times the guaranteed ad has been presented on the third-party resources relative to the specified number of times the guaranteed ad is required to be presented;
adjusting the baseline offer based on the actual delivery level;
identifying, for each non-guaranteed ad, an offer from at least one of an offer per impression, an offer per selection, or an offer per conversions;
selecting, by the one or more processors and based on an arbitration process that uses the adjusted baseline bid and the offers of the at least one non-guaranteed ads in the set of eligible ads, a set of winning ads to serve from among the set of eligible ads; and
transmitting, in response to a request and over a communications network, machine executable instructions that initiate presentation of the set of wining ads at a user device.

44. The method of claim 43, wherein performing the arbitration process further includes determining a placement order of the selected ads.

45. The method of claim 43, wherein a determination whether a marked preemption is set is performed prior to the arbitration process to ensure serving of a given ad.

46. The method of claim 43, wherein the method further comprises removing a market preemption when a predetermined condition is no longer met.

47. The method of claim 43, wherein:
when a first delivery method is pre-selected and a particular guaranteed ad in the set of eligible ads is determined to be over-delivered, reducing a price offer for the particular guaranteed ad by an adjustment factor and allowing the particular guaranteed ad to participate in one or more future arbitrations at a lower offer based on the reduced price offer; and
when a second delivery method is pre-selected and the particular guaranteed ad in the set of eligible ads is determined to be over-delivered, not changing the price offer associated with the ad and allowing over-delivery to continue.

48. The method of claim 43, wherein, when a particular guaranteed ad in the set of eligible ads is determined to be under-delivered, increasing a price offer for the particular guaranteed ad by an adjustment factor to project winning one or more future arbitrations based on the increased price offer.

49. The method of claim 43, further comprising:
determining whether an ad service guarantee is satisfied; and
upon determination that the ad service guarantee is satisfied, preparing to serve one or more additional ads subject to a current market condition.

50. The method of claim 43, wherein, when a previously determined over-delivery method is selected, a price offer for a given ad is unchanged in order to allow over-delivery to continue.

51. A system comprising one or more processors configured to:
identifying, by one or more processors, a set of eligible ads that are eligible for delivery to a user device, including:
identifying, for inclusion in the set of eligible ads, a guaranteed ad that is required to be presented on third-party resources at least at a specified number of times; and
identifying, for inclusion in the set of eligible ads at least one non-guaranteed ad;
determining, for the guaranteed ad, a baseline offer based on a total amount that will be paid for presentation of the guaranteed ad the specified number of times on the third party resources;
determining an actual delivery level that describes a number of times the guaranteed ad has been presented on the third-party resources relative to the specified number of times the guaranteed ad is required to be presented;
adjusting the baseline offer based on the actual delivery level;
identifying, for each non-guaranteed ad, an offer from at least one of an offer per impression, an offer per selection, or an offer per conversions;
selecting, by the one or more processors and based on an arbitration process that uses the adjusted baseline bid and the offers of the at least one non-guaranteed ads in the set of eligible ads, a set of winning ads to serve from among the set of eligible ads; and
transmitting, in response to a request and over a communications network, machine executable instructions that initiate presentation of the set of wining ads at a user device.

52. The system of claim 51, wherein the one or more processors are further configured to, in performing the arbitration process, determine a placement order of the set of eligible ads.

53. The system of claim 51, wherein a determination whether a marked preemption is set is performed prior to the arbitration process to ensure serving of a given ad.

54. The system of claim 51, wherein the one or more processors are further configured to remove a market preemption when a predetermined condition is no longer met.

55. The system of claim 51 wherein:
when a first delivery method is pre-selected and a particular guaranteed ad in the set of eligible ads is determined to be over-delivered, the one or more processors are further configured to reduce a price offer for the particular guaranteed ad by an adjustment factor and allow the particular guaranteed ad to participate in one or more future arbitrations at a lower offer based on the reduced price offer; and
when a second delivery method is pre-selected and the particular guaranteed ad in the set of eligible ads is determined to be over-delivered, the one or more processors are further configured to not change the price offer associated with the ad and to allow over-delivery to continue.

56. The system of claim 51, wherein the one or more processors are further configured to, when a particular guaranteed ad in the set of eligible ads is determined to be under-delivered, increase a price offer for the particular guaranteed ad by an adjustment factor to project winning one or more future arbitrations based on the increased price offer.

57. The system of claim 51, wherein when a previously determined over-delivery method is selected, a price offer for a given ad is unchanged in order to allow over- delivery to continue.

58. The system of claim 51, wherein the one or more processors are further configured to:
determine whether an ad service guarantee is satisfied; and
upon determination that the ad service guarantee is satisfied, prepare to serve one or more additional ads subject to a current market condition.

59. A non-transitory computer-readable storage medium on which computer readable instructions of a program are stored, the instructions, when executed by one or more processors, cause the one or more processors to perform a method comprising:
identifying, by one or more processors, a set of eligible ads that are eligible for delivery to a user device, including:
identifying, for inclusion in the set of eligible ads, a guaranteed ad that is required to be presented on third-party resources at least at a specified number of times; and
identifying, for inclusion in the set of eligible ads at least one non-guaranteed ad;
determining, for the guaranteed ad, a baseline offer based on a total amount that will be paid for presentation of the guaranteed ad the specified number of times on the third party resources;
determining an actual delivery level that describes a number of times the guaranteed ad has been presented on the third-party resources relative to the specified number of times the guaranteed ad is required to be presented;
adjusting the baseline offer based on the actual delivery level;
identifying, for each non-guaranteed ad, an offer from at least one of an offer per impression, an offer per selection, or an offer per conversions;
selecting, by the one or more processors and based on an arbitration process that uses the adjusted baseline bid and the offers of the at least one non-guaranteed ads in the set of eligible ads, a set of winning ads to serve from among the set of eligible ads; and
transmitting, in response to a request and over a communications network, machine executable instructions that initiate presentation of the set of wining ads at a user device.

60. The storage medium of claim 60, wherein a determination whether a marked preemption is set is performed prior to the arbitration process to ensure serving of a given ad.

61. The storage medium of claim 59, wherein:
when a first delivery method is pre-selected and a particular guaranteed ad in the set of eligible ads is determined to be over-delivered, reducing a price offer for the particular guaranteed ad by an adjustment factor and allowing the particular guaranteed ad to participate in one or more future arbitrations at a lower offer based on the reduced price offer; and
when a second delivery method is pre-selected and the particular guaranteed ad in the set of eligible ads is determined to be over-delivered, not changing the price offer associated with the ad and allowing over-delivery to continue.

62. The storage medium of claim 59, wherein when a particular guaranteed ad in the set of eligible ads is determined to be under-delivered, increasing a price offer for the particular guaranteed ad by an adjustment factor to project winning one or more future arbitrations based on the increased price offer.

63. (canceled)
